(19) United States
(12) Patent Application Publication
(10) Pub. No.: US 2006/0096645 A1
(43) Pub. Date: May 11, 2006

(54) System for direct electrically operated hydraulic control valve

(76) Inventor: Morten Halvorsen, Kristiansand (NO)

Correspondence Address: DUANE, MORRIS, LLP, 3200 SOUTHWEST FREEWAY, SUITE 3150, HOUSTON, TX, 77027, US

(21) Appl. No.: 10/984,033

(22) Filed: Nov. 9, 2004

(51) Int. Cl. F15B 13/044

(52) U.S. Cl. 137/625.65

(57) ABSTRACT

A hydraulic directional control valve assembly adapted for use subsea without a pilot valve stage and its methods of use are disclosed. The hydraulic directional control valve assembly comprises a pulse operated hydraulic directional control valve, a separate fail safe mechanism to bring the valve to a predetermined position and a single electric actuator operatively connected to the hydraulic directional control valve, the hydraulic directional control valve having a first and second position relative to electric actuator, the electric actuator further adapted to selectively change the position of the hydraulic directional control valve with respect to passageway with which hydraulic directional control valve may be in communication, in this manner selectively change the direction of the fluid flow through hydraulic directional control valve. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### FIELD OF THE INVENTION

The invention relates to directional control valves. The invention more specifically relates to a hydraulic directional control valve operated by an electric solenoid without a pilot valve stage as may be required for a subsea production control system, further comprising a fail safe latch.

### BACKGROUND OF THE INVENTION

Electro-hydraulic operated valves are used subsea. Referring to FIG. 1, typical valves comprise two separate solenoids 101a, 101b. Additionally, pilot valve stages 102a, 102b are also typically present. Valve 103 is then disposed intermediate pilot valves stages 102a, 102b. Valve 103 may be a pulse operated shear type seal valve and may further incorporate a fail safe latch function.

A pilot valve, e.g 102a,102b, often consists of many small, complex parts, comprising small pieces and narrow fluid passages. In these configurations, problems may exist as a result of using a pilot valve stage, including leaking and clogging. Either or both of these problems reduce the effectiveness of the overall valve assembly. Valve assemblies that do not incorporate a pilot valve stage would not have these problems.

### BRIEF DESCRIPTION OF THE DRAWINGS

The features, aspects, and advantages of the present invention will become more fully apparent from the following description, appended claims, and accompanying drawings in which:

FIG. 1 is a block diagram of a prior art valve assembly with a pilot stage;

FIG. 2 is a block diagram of an embodiment of the present invention without a pilot stage;

FIG. 3 is a cutaway view in partial perspective of an embodiment of the present invention without a pilot stage;

FIG. 4 is a cutaway view of an embodiment of the present invention without a pilot stage illustrating fluid flow when the valve assembly is in a closed position; and

FIG. 5 is a cutaway view of an embodiment of the present invention without a pilot stage illustrating fluid flow when the valve assembly is in an open position.

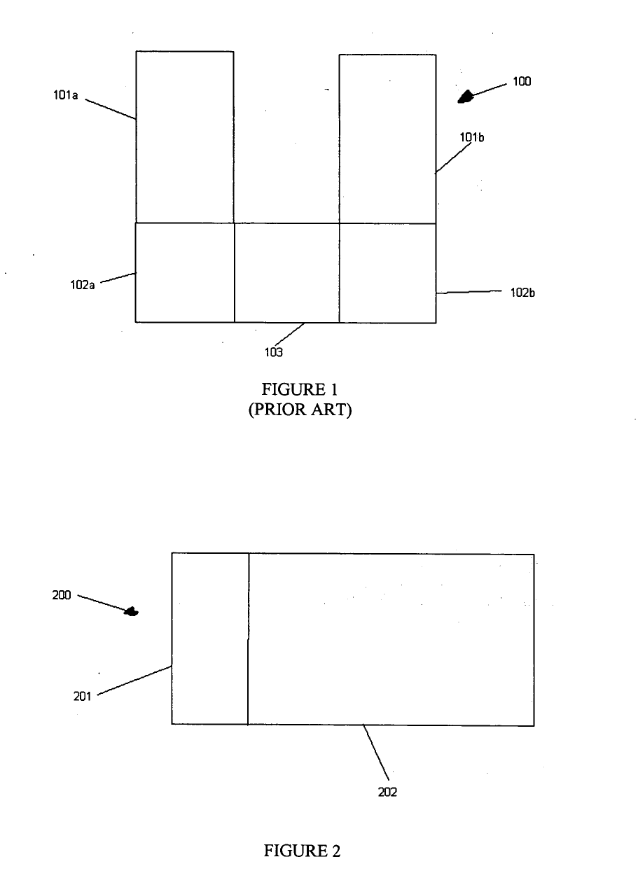

### DETAILED DESCRIPTION OF AN EXEMPLARY EMBODIMENT

Referring generally to FIG. 2, hydraulic directional control valve assembly 200 is, in a preferred embodiment, adapted for use subsea without a pilot valve stage. Hydraulic directional control valve assembly 200 comprises hydraulic directional control valve 202 and a single electric actuator 201 operatively connected to hydraulic directional control valve 202.

In a preferred embodiment, hydraulic directional control valve 202 further comprises a latch mechanism, as described in more detail herein below, e.g. for a fail safe latch out function, and may comprise a pulse operated, shear type seal valve.

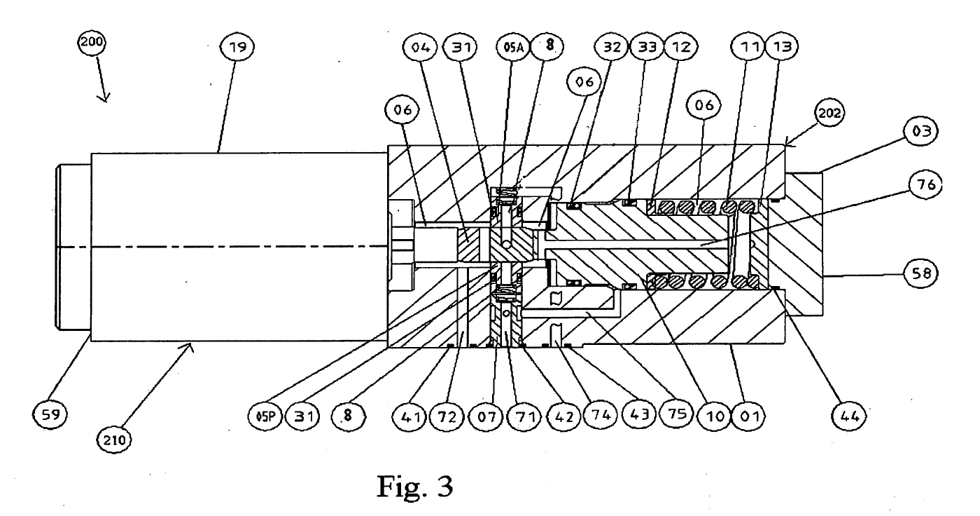

As described herein below in more detail and referring generally to FIG. 3, hydraulic directional control valve 202 has a first and a second position relative to electric actuator 210. Electric actuator 210 may further be adapted to selectively change the position of hydraulic directional control valve 202 with respect to a passageway with which directional hydraulic directional control valve 202 may be in communication. In this manner, the direction of the fluid flow through directional hydraulic directional control valve 202 may be selectively changed.

Electric actuator 210 may comprise an electric solenoid, an electric motor, or the like, or a combination thereof, and is preferably a double acting electrically actuable solenoid. Further, as used herein, those of ordinary skill in the art will understand that solenoid 19, when described as moving, means that the moving portion of solenoid 19 is that which moves, not the entire solenoid which may further comprise windings, a housing, and the like.

Referring still to FIG. 3, which illustrates an exemplary hydraulic directional control valve assembly 200 in more detail, hydraulic directional control valve assembly 200 comprises housing 01 further comprising housing annulus 06; dual acting solenoid 19; cover 03; supply pressure port 71; return line port 72; slide 04 disposed within housing annulus 06; free moving separate piston 10 slidably disposed within housing annulus 06, intermediate cover 03 and slide 04; function line port 74; and spring 11.

As noted above, electric actuator 210 is preferably a double or dual acting electrically actuable solenoid 19 and may be disposed at a first end of housing 01.

Cover 03 may be sealingly disposed at a second end of housing 01 and may be removably secured to the second end of housing 01, e.g. by socket screw 58, or permanently secured to the second end of housing 01.

Additionally, one or more seals 44 may be disposed in a sealing relation between cover 03 and housing 01.

Supply pressure port 71 defines a first passageway to slide 04 from the exterior of housing 01 and a second passageway 75 from the first passageway into housing annulus 06. Return line port 72 defines a passageway into housing annulus 06 from the exterior of housing 01. Function line port 74 defines a passageway to slide 04 from the exterior of housing 01. Internal bore 76 defines a passageway between housing annulus 06 on each side of free moving piston 10.

Piston 10 is typically slidably disposed within housing annulus 06, intermediate cover 03 and slide 04. Spring 11 may be disposed within housing annulus 06 intermediate cover 03 and piston 10. In this configuration, spring 11 is adapted to communicate with both piston 10 and cover 03 to urge piston 10 towards slide 04 and bring the hydraulic directional control valve to a safe position.

Washer 12 may be used for supporting and/or fixing spring 11. Washer 12 may further be used to aid in adjusting spring force exerted by spring 11 such as by increasing or decreasing the thickness of washer 12 prior to its installation. Spring 11 may be used to oppose the pressure force from latch piston 10 and frictional forces in the shear type seal valve and bring slide 04 to a safe position if the supply pressure falls below a predetermined pressure level.

Function line port 74 may be disposed within slide 04 where function line port 74 is adapted to be in fluid communication with supply pressure port 71, return line 72, or both. One or more spacers 07 may be disposed within supply pressure port 71.

Slide 04 may be disposed within housing annulus 06 intermediate and in communication with the moving portion of solenoid 19 and latch piston 10 and may further comprise function line port 74. In a preferred embodiment, slide 04 is a shear type seal slide. Seats, e.g. supply seat 05P and function port seat 05A, may be disposed within housing 01 in communication with slide 04 to form a seal. In a preferred embodiment, supply seat 05P and function port seat 05A are shear type seal seats. One or more packings 31 may be disposed about a circumference of supply seat 05P and function port seat 05A, sealing off the line pressures against the housing annulus 06 pressure.

Latch piston 10 may further comprise a shoulder where a portion of spring 11, e.g. an end portion, is in communication with the shoulder. Washer 12 may further be disposed intermediate the shoulder and the end portion of spring 11. Washer 13 may be present proximate the opposite end portion of spring 11, intermediate spring 11 and cover 03. One or more packings, e.g. U-packings 32 and 33, may be disposed about an outer circumference of latch piston 10 opposite the shoulder where the packings are in communication with the exposed circumference of the housing annulus 06.

One or more socket screws 58 may be disposed within cover 03 disposed at second end of housing 01. One or more seals 44, which may be of the type generally known in the art such as an O-ring, may be present to seal cover 03 from housing annulus 06.

Springs 08 within each chamber urge supply seat 05P and function port seat 05A against slide 04. Spacer 07 may additionally exist in the chambers and be in communication with supply port seat 05P.

One or more seals 44 may be present and disposed in a sealing relation between cover 03 and housing 01.

In the operation of a preferred embodiment, hydraulic directional control valve assembly 200 is typically a three-way, two-position valve, i.e. there are three connected ports configured such that fluid flow can go in one of two paths, e.g. from supply pressure port 71 through function port 74 or from function port 74 through return port 72.

In a typical configuration, supply pressure port 71 is connected to an external supply pressure source (not shown in the figures). Function line port 74 is connected to an external spring return hydraulic actuator (not shown in the figures). Return line port 72 is connected to an external return line (not shown in the figures).

Typically, before any hydraulic pressure or electric power is applied to hydraulic directional control valve assembly 200, slide 04 is resting in a “closed” position, as forced by spring 11. Pressure is applied on supply pressure port 71, e.g. from a fluid line. Fluid under pressure enters housing annulus 06, resulting in a fluid force being applied on a differential area between two U-packings 32, 33. The fluid force moves latch piston 10 as the fluid force overcomes the force of spring 11. This helps ensure that latch piston 10 and spring 11 are completely removed from influencing slide 04 and solenoid 19. The latch function will therefore be “invisible” during normal operation as long as the supply pressure is above a predetermined “fail safe level.” Above the predetermined “fail safe level,” hydraulic directional control valve assembly 200 can be pulse operated.

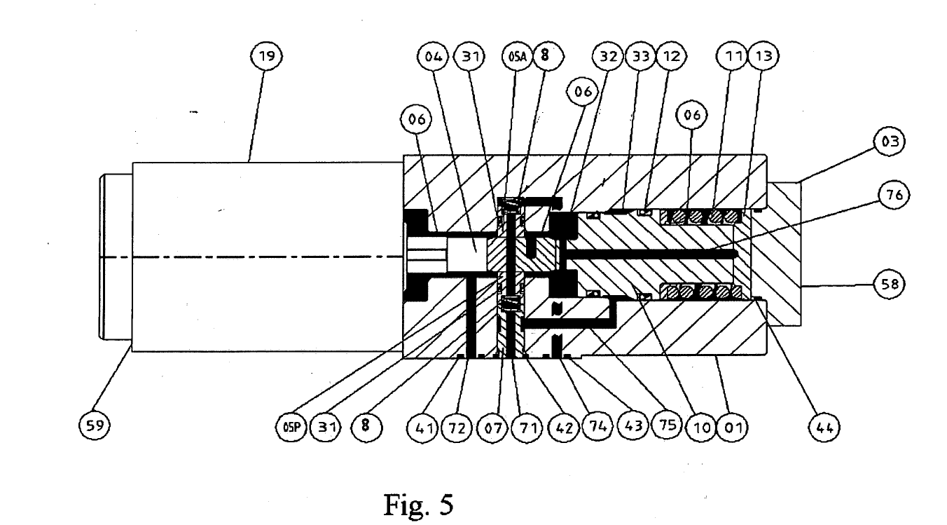

Referring additionally to FIG. 5, applying an electric pulse for closing action of solenoid 19 may result in an “open” or “closed” position being accomplished for the hydraulic directional control valve assembly 200. Typically, pulse operations comprise applying a short electric pulse to solenoid 19, e.g. a pulse of about one to three seconds in duration. Solenoid 19 moves slide 04 into an “open” position, allowing fluid to traverse supply pressure port 71 through slide 04 through to function line 74, then out to the external hydraulic spring return actuator (not shown in the figures) filling up the actuator volume and operating the actuator. Return line 72 is blocked off from the fluid flow due to slide 04 and supply seat 05P and function port seat 05A.

When the electric pulse is stopped, slide 04 may remain in the “open” position due to the frictional forces between slide 04 and supply seat 05P and function port seat 05A.

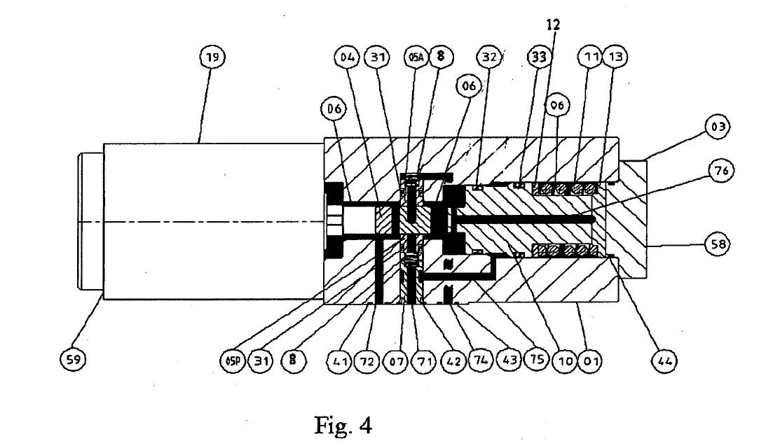

Referring additionally to FIG. 3 and FIG. 4, a further electrical signal results in a force from solenoid 19 which moves slide 04 over to a “closed” position. In the closed position, fluid flow is directed from an external hydraulic actuator pushing the fluid through function port 74 through slide 04 out into housing annulus 06 and out return line port 72. Supply port seat 05P is sealed off against the slide 04.

If, when the slide is in the open position, the supply pressure falls below the predetermined fail safe pressure, the spring force from spring 11 overcomes the latch piston force and the frictional force between slide 04, supply seat 05P, and function port seat 05A and moves latch piston 10, slide 04, and solenoid 19 over to the “closed” position. When the slide is in the “closed” position, fluid flow, as described above, is directed out return line port 72, bringing the external hydraulic actuator to a fail safe position.

It will be understood that various changes in the details, materials, and arrangements of the parts which have been described and illustrated above in order to explain the nature of this invention may be made by those skilled in the art without departing from the principle and scope of the invention as recited in the following claims.

I claim:

1. A hydraulic directional control valve assembly adapted for use subsea without a hydraulic pilot stage, comprising:
a. a hydraulic directional control valve comprising a first position and second position, the first position and the second position adapted to affect fluid flow within a passageway with which the hydraulic directional control valve is in communication; and
b. a single electric actuator operatively connected to the hydraulic directional control valve, the electric actuator having a first position and a second position relative to the hydraulic directional control valve, the electric actuator further adapted to selectively change a position of the hydraulic directional control valve between its first position and its second position.

2. The hydraulic directional control valve assembly of claim 1, wherein the hydraulic directional valve assembly further comprises a fail safe latch adapted to bring the hydraulic directional valve to a predetermined position.

3. The hydraulic directional control valve assembly of claim 1, wherein the hydraulic directional valve further comprises a pulse operated, shear type seal valve.

4. The hydraulic directional control valve assembly of claim 1, wherein the electric actuator further comprises at least one of (a) an electric solenoid or (b) an electric motor.

5. The hydraulic directional control valve assembly of claim 4, wherein the electric solenoid is a dual acting electrically actuatable solenoid.

6. The hydraulic directional control valve assembly of claim 1, further comprising a seal operatively coupled to the electric actuator.

7. The hydraulic directional control valve assembly of claim 6, wherein the seal is a shear type seal.

8. A solenoid activated valve assembly adapted for use subsea, comprising:
a. a housing comprising a housing annulus and an exterior;
b. a dual acting solenoid disposed at a first end of the housing and further comprising a moving portion;
c. a cover sealingly disposed at a second end of the housing opposite the first end of the housing;
d. a slide disposed within the housing annulus intermediate and in communication with a first portion of a piston and the moving portion of the solenoid, the piston slidably disposed within the housing annulus intermediate the cover, the piston further comprising a first portion and a second portion;
e. a function line port disposed within the slide and adapted to be in fluid communication with at least one of (i) a supply pressure port defining a first passageway to the slide from the exterior of the housing and defining a second passageway from the first passageway to the housing annulus or (ii) a return line defining a second passageway to the housing annulus from the exterior of the housing; and
i. a spring disposed within the housing annulus intermediate the cover and the piston, the spring adapted to be in communication with the piston and the cover.

9. The solenoid activated subsea valve assembly of claim 8, further comprising a seal sealingly disposed between the cover and the housing.

10. The solenoid activated subsea valve assembly of claim 8, wherein the cover is at least one of (i) removably secured to the second end of the housing or (ii) permanently secured to the second end of the housing.

11. The solenoid activated subsea valve assembly of claim 8, wherein the piston further comprises a shoulder against which a washer is disposed intermediate the shoulder and an end of the spring, a predetermined portion of the spring being in communication with the shoulder.

12. The solenoid activated subsea valve assembly of claim 8, wherein the slide is a shear type seal slide.

13. The solenoid activated subsea valve assembly of claim 8, wherein the spring is adapted to urge the piston towards the slide.

14. The solenoid activated subsea valve assembly of claim 8, further comprising a spacer disposed within the supply pressure port.

15. A method of using a hydraulic directional control valve assembly subsea without a hydraulic pilot stage, comprising:
a. connecting a supply pressure port of a hydraulic directional control valve assembly to an external supply pressure source;
b. connecting a function line port of the hydraulic directional control valve assembly to a spring return hydraulic actuator;
c. connecting a return line port of the hydraulic directional control valve assembly to an external return line;
d. using a spring disposed within the hydraulic directional control valve assembly to urge a slide disposed within the hydraulic directional control valve assembly into a first closed position;
e. applying fluid pressure to a latch piston disposed within the hydraulic directional control valve assembly via fluid entering from the supply pressure port; and
f. allowing the hydraulic directional control valve assembly to permit fluid flow through the hydraulic directional control valve assembly when the fluid pressure is sufficient to overcome pressure exerted by the spring.

16. The method of claim 15, further comprising:
a. allowing fluid under pressure to enter a housing annulus disposed within the hydraulic directional control valve assembly, wherein the latch piston is further disposed within the housing annulus, resulting in a fluid force being applied on a differential area of the latch piston between a first packing and a second packing disposed within the hydraulic directional control valve assembly about an outer circumference of the latch piston opposite a shoulder where the packings are in communication with the exposed circumference of the housing annulus;
b. using the fluid force to move the latch piston as the fluid force overcomes a spring force of the spring.

17. The method of claim 15, further comprising:
a. applying a first electric pulse to a solenoid disposed within the hydraulic directional control valve assembly to permit the solenoid to move the slide into an open position, allowing fluid to traverse from a supply port disposed within the hydraulic directional control valve assembly through the slide and function line port, the slide blocking a return line port from a fluid flow; and
b. applying a second electrical signal to create a force from the solenoid to move the slide over to a closed position.

18. The method of claim 17, wherein, when the first electric pulse is stopped, slide remains in position due to the frictional forces between the slide and a seat disposed within the hydraulic directional control valve assembly.

19. The method of claim 17, wherein, when the slide is in the open position, if the pressure supply falls below a predetermined fail safe pressure, the fluid flow is directed out the return line port by permitting the spring force from the spring to move the latch piston, the slide, and the solenoid to the closed position by overcoming at least one of (i) a latch piston force or (ii) a frictional force between the slide and the seat.

20. The method of claim 17, wherein, when the slide is in the closed position, the fluid flow is directed from an external hydraulic actuator through the function line port through the slide out and into the housing annulus and out the return line port, and the supply pressure port 71 is sealed off against the fluid flow by the slide and a seat.
